(19) United States
(12) Patent Application Publication
(10) Pub. No.: US 2025/0265631 A1
(43) Pub. Date: Aug. 21, 2025

(54) INFORMATION PROCESSING METHOD, INFORMATION PROCESSING SYSTEM, AND PROGRAM

(71) Applicant: ARCHAIC INC., Tokyo (JP)

(72) Inventors: Hongzhi YANG, Tokyo (JP); Zhaoxu WANG, Tokyo (JP); Atsushi YOKOYAMA, Tokyo (JP)

(21) Appl. No.: 18/858,332

(22) PCT Filed: Apr. 20, 2023
(86) PCT No.: PCT/JP2023/015713

§ 371 Date: Mar. 12, 2025

(30) Foreign Application Priority Data
Apr. 21, 2022 (JP) 2022-069995

(51) Int. Cl. G06Q 30/0601; G06Q 30/0201

(52) U.S. Cl. CPC G06Q 30/0631; G06Q 30/0201

(57) ABSTRACT

An information processing method includes the steps of: acquiring information relating to a plurality of previous purchase products of each user in a plurality of electronic commerce means; generating a plurality of user vectors relating to the user on the basis of the acquired information relating to the plurality of previous purchase products; and outputting information relating to a recommendation product for the user on the basis of the similarity between a vector generated on the basis of information relating to a target product in one electronic commerce means and at least one vector among a plurality of user vectors relating to the user.

### RELATED APPLICATIONS

The present application is a National Phase of International Application No. PCT/JP2023/015713 filed Apr. 20, 2023, which claims priority to Japanese Application No. 2022-069995, filed Apr. 21, 2022.

### BACKGROUND

### 1. Technical Field

The present disclosure relates to an information processing method, an information processing systems, and a program.

### 2. Description of Related Art

In recent years, in the electronic commerce in which a variety of services, contents, products are provided, the development of recommendation techniques which match users' purchase history and preferences has been progressing. For example, Japanese Unexamined Patent Application, First Publication No. 2016-062290 which will be described below discloses a technique for determining a recommended product associated with a product purchased by a user.

### SUMMARY

In the technique disclosed in JP2016-062290 A described above, only recommended products obtained from purchase information in one electronic commerce transaction can be determined and the accuracy of recommendations to a user is not sufficient.

Therefore, the present disclosure was made in consideration of the above problems, and an object of the present disclosure is to provide an information processing method, an information processing system, and a program which are capable of recommending more accurate products to a user.

According to the present disclosure, a information processing method including acquiring information relating to a plurality of previous purchase products of each user in a plurality of electronic commerce means, generating a plurality of user vectors relating to the user on the basis of the acquired information relating to the plurality of previous purchase products, and outputting information relating to a recommendation product for the user on the basis of the similarity between a vector generated on the basis of information relating to a target product in one electronic commerce means and at least one vector among a plurality of user vectors relating to the user is provided.

Also, according to the present disclosure, an information processing system including a purchase information acquisition unit which acquires information relating to a plurality of previous purchase products of each user in a plurality of electronic commerce means, a user vector generation unit which generates a plurality of user vectors relating to the user on the basis of the acquired information relating to the plurality of previous purchase products, and a recommendation information output unit which outputs information relating to a recommendation product for the user on the basis of a similarity between a vector generated on the basis of information of the target product in one electronic commerce means and at least one vector among a plurality of user vectors relating to the user is provided.

Furthermore, according to the present disclosure, a program causing a computer to function as an information processing system including: by a processor, acquiring information relating to a plurality of previous purchase products of each user in a plurality of electronic commerce means, generating a plurality of user vectors relating to the user on the basis of the acquired information relating to the plurality of previous purchase products, and outputting information relating to a recommendation product for the user on the basis of the similarity between a vector generated on the basis of information relating to a target product in one electronic commerce means and at least one vector among a plurality of user vectors relating to the user is provided.

According to the present disclosure, it is possible to recommend a more appropriate product to a user.

### BRIEF DESCRIPTION OF THE DRAWINGS

FIG. 1 is a diagram showing an overview of an information processing system 1 according to an embodiment.

FIG. 2 is a diagram for explaining the related art.

FIG. 3 is a diagram showing an example of a hardware configuration of information processing device 10 according to the embodiment.

FIG. 4 is an example of a block diagram of the information processing device 10 according to the embodiment.

FIG. 5 is a flowchart for describing an example of a flow of a user vector generation process in the information processing system 1 according to the embodiment.

FIG. 6 is a diagram for explaining a flow of a user vector generation process in the information processing system 1 according to the embodiment.

FIG. 7 is a flowchart for describing an example of a flow of a recommendation product output process of the information processing system 1 according to the embodiment.

FIG. 8 is a diagram for explaining a flow of a recommendation product output process of the information processing system 1 according to the embodiment.

### DETAILED DESCRIPTION OF EMBODIMENTS

The preferred embodiment of the present disclosure will be explained in details below with reference to the accompanying drawings. In this specification and the drawings, constituent elements having substantially the same functional configurations are denoted by the same reference numerals and redundant explanations thereof will be omitted.

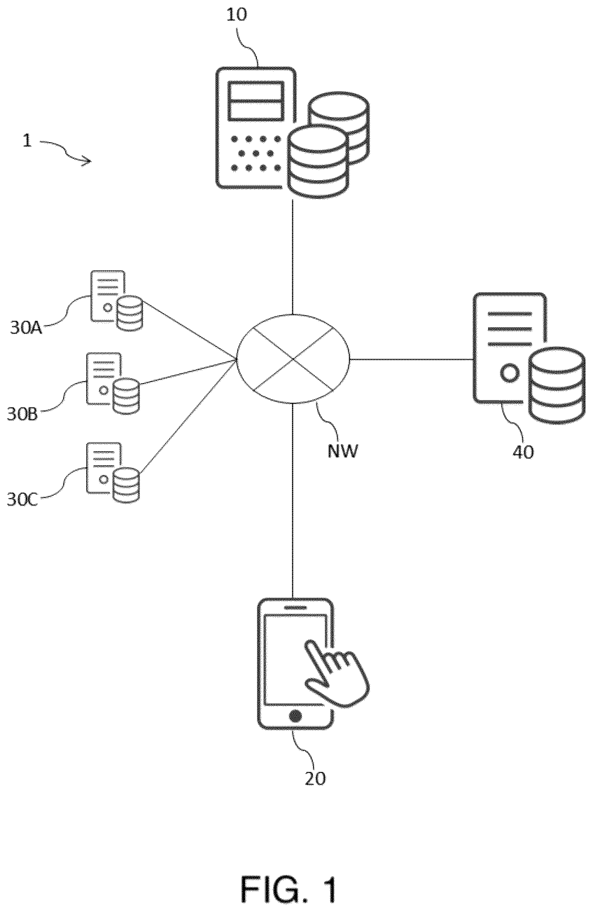

FIG. 1 is a diagram showing an overview of the information processing system 1 according to an embodiment. As shown in the drawing, the information processing system 1 includes the information processing device 10. The information processing system 1 may communicate with a user terminal 20, an EC server 30, and an EC server 40 over a network NW.

The information processing device 10 is composed of one or more servers or computers having a hardware configuration as will be described below. As will be described below, the information processing device 10 may generate a user vector unique to a user on the basis of the services, the content, and the products that the user has purchased or used in a plurality of electronic commerce services that the user has used previously. Furthermore, the information processing device 10 may directly or indirectly present recommendation products to the user on the basis of a comparison (for example, similarity) with the user vector for a plurality of target products (which may include services and content) that the user is considering purchasing or using (or which are unrelated to the wishes of the user). The information processing system 1 according to the embodiment may be implemented mainly using the functions included in the information processing device 10.

The user terminal 20 may be composed of, for example, a mobile terminal, a tablet terminal, a personal computer, a game console, or any other terminal device. By operating the user terminal 20, the user may communicate with, for example, EC servers 30 and 40 or other devices, which will be described later over the network NW and purchase products, services, and content, for example, through electronic commerce.

The EC servers 30 and 40 are composed of one or more servers or computers. The EC servers 30 (30A, 30B, 30C, and . . . ) and the EC servers 40 are servers for providing management for a product and a service for electronic commerce when a user for example, who operates the user terminal 20 purchases a product, a service, and a content, for example. In the embodiment, a situation in which a user has previously purchased each product, service, and content, for example, previously provided by the plurality of EC servers 30 and subsequently the user attempts to purchase any product, service, and content, for example, provided by the EC servers 40 is assumed. The types of merchandise provided by the EC servers 30 and 40 are not particularly limited and may be general EC products, food and drink products or content such as movies, travel, news, music, and recreation.

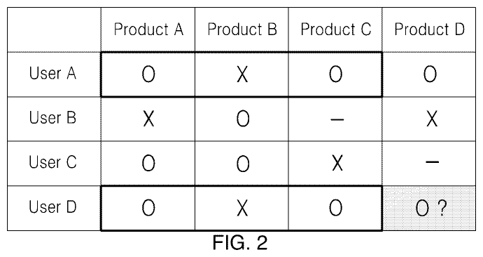

Examples of the techniques in the related art for presenting recommendation products to users include collaborative filtering, content-based recommendation, for example. The collaborative filtering may be used, for example, to identify recommendation products for a user who tends to have the same purchasing history on the basis of the previous product purchasing history, for example, of a plurality of users. FIG. 2 is a diagram for explaining the related art. As shown in FIG. 2, when a user A purchases products A, C, and D and when a user D purchases products A and C but does not purchases a product B, a product D may be presented as a recommendation product.

Also, content-based recommendation involves generating a feature vector from each product or content and calculating a similarity between a plurality of products based on the feature vectors to identify recommendation products. The feature vector may be, for example, the number of frequently occurring nouns divided by the total number of nouns.

Here, in such recommendation methods in the related art, an amount of features, for example, changes when merchandise (products, services, content) differs in accordance with a platform. For this reason, although a recommendation product is specified for a user for each EC service, an amount of features is acquired for each merchandise or platform, and thus the amount of features is not included in other merchandise or platforms. For this reason, the tendency of recommending products to users changes in accordance with the EC services.

Thus, the information processing system 1 according to the embodiment acquires information relating to a plurality of previous purchase products of each user from the plurality of EC servers, generates a plurality of user vectors relating to the user on the basis of the information relating to the plurality of acquired previous purchase products, and outputs information regarding a recommendation product for a user on the basis of the similarity between a vector generated on the basis of information regarding a target product provided by an EC server a user wants to use and at least one vector among a plurality of user vectors relating to the user. That is to say, the information processing system 1 converts the previous purchase products of the user from the EC server 30 into vectors, generates a plurality of user vectors specific to the user, and makes recommendations to the user by comparing these user vectors with vectors obtained from target products on an EC site that the user wants to use.

As a result, even if a user purchases various products, for example, from a plurality of EC sites, a user vector which has the preferences of the user, for example, across platforms included therein may be generated and recommendation products may be presented using this. Thus, regardless of the EC site a user uses, the user may obtain information regarding recommendation products according to his/her interests and characteristics.

In the information processing system 1 according to the embodiment, for example, the information regarding the recommendation product may be information obtained via a web service such as a software as a service (SaaS) which may be provided from the information processing device 10 by the user terminal 20 or may be information provided from the information processing device 10 via an application programming interface (API), for example, and presented on an EC site provided by the EC server 40.

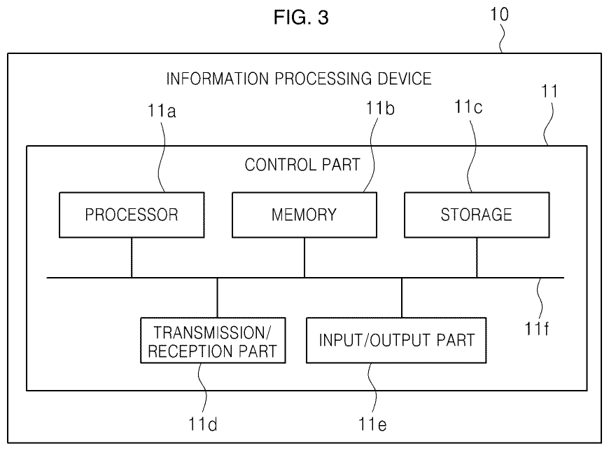

FIG. 3 is a diagram showing an example of a hardware configuration of the information processing device 10 according to the embodiment. As shown in the drawing, the information processing device 10 includes a control unit 11.

A processor 11a is a calculation device which controls an operation of the control unit 11, controls the transmission and reception of data between elements, and performs a process, for example, necessary for executing programs. In this embodiment, the processor 11a is, for example, a central processing unit (CPU) and executes programs stored in a storage 11c which will be described later and loaded on a memory 11b to perform each process.

The memory 11b includes a main memory device composed of a volatile memory device such as a dynamic random access memory (DRAM) and an auxiliary memory device composed of a non-volatile memory device such as a flash memory or a hard disc drive (HDD). The memory 11b is used as a working region for the processor 11a and also has a boot loader which is performed when the control unit 11 is started up, various setting information, for example, stored therein.

The storage 11c has programs, information used for various processes stored therein. For example, the storage 11c may have a program for displaying information, for example, stored therein.

A transmission/reception unit 11d connects the control unit 11 to a network such as the Internet network and may include a communication interface such as a local area network (LAN), a wide area network (WAN), infrared rays, wireless, wireless fidelity (Wi-Fi), a point-to-point (P2P) network, a telecommunications network, cloud communication, long-term evolution (LTE), Bluetooth (registered trademark), or Bluetooth Low Energy (BLE).

An input/output unit 11e is an interface through which input/output devices are connected.

A bus 11f transmits, for example, address signals, data signals, and various control signals between the processor 11a, the memory 11b, the storage 11c, the transmission/reception unit 11d, and the input/output unit 11e which are connected.

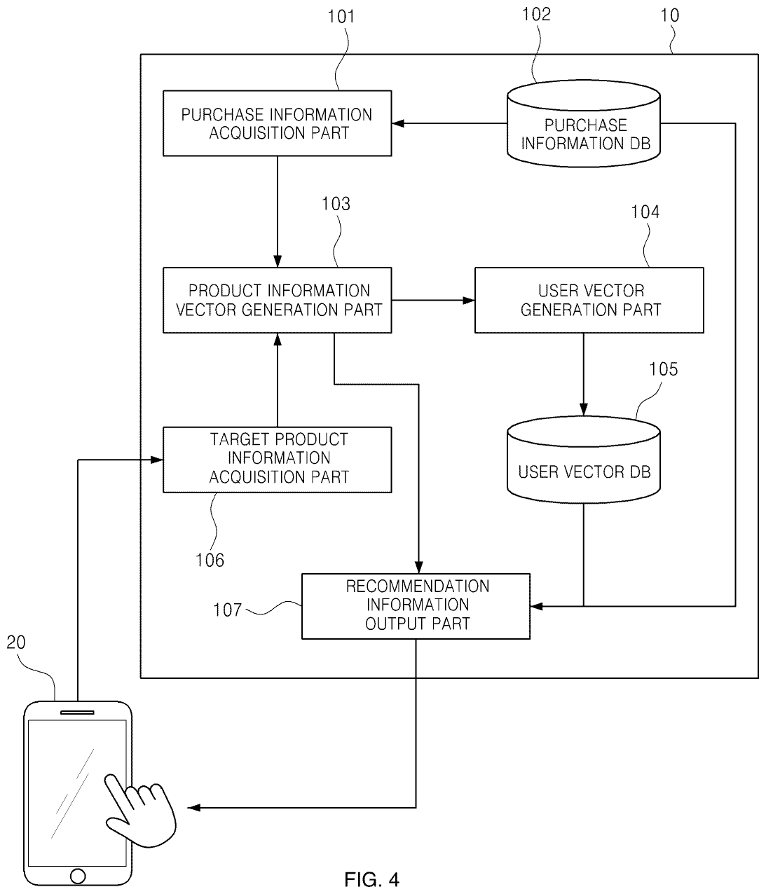

FIG. 4 is an example of a block diagram of the information processing device 10 according to the embodiment. The functions shown in this block diagram may be embodied using various hardware included in the above-described hardware configuration. The information processing device 10 according to the embodiment includes a purchase information acquisition unit 101, a purchase information database (DB) 102, a product information vector generation unit 103, a user vector generation unit 104, a user vector DB 105, a target product information acquisition unit 106, and a recommendation information output unit 107.

The purchase information acquisition unit 101 has a function of acquiring previous purchase information of a user stored in the purchase information DB 102. Furthermore, the purchase information acquisition unit 101 may acquire previous purchase information of a user from an external source. Purchase information is information regarding products (also called merchandise) that a user has purchased previously at one or more electronic commerce sites that the user has used. Such information may be stored in the purchase information DB 102 or may be appropriately acquired from each of the EC servers 30 which provide each electronic commerce. The purchase information may be, for example, at least a part of text information (for example, travel plans, music titles and lyrics, meal menus), binary information such as images, videos, and audio, meta information, for example, posted on a website introducing the products purchased by the user.

The product information vector generation unit 103 generates a product information vector on the basis of the purchase information and the information of the target product which will be described later. For example, the product information vector generation unit 103 generates a product information vector by documenting the purchase information stored in the purchase information DB 102 and the DBs of various EC servers 30 and further performing latent expression (characterization). There are no particular limitations on the method for generating a vector and a general method may be used. The means for such vectorization is not particularly limited. For example, methods for generating a vector include an AI-based Transformer and TF-IDF methods. Furthermore, elements of these vectors may include artificially created ones (for example, interest categories). In addition, for example, when the purchase information includes text information, a product information vector may be generated directly by performing a natural language process on the text information or the product information may be vectorized on the basis of text information which has been summarized or converted using a method such as a Large Language Model (LLM). Moreover, when the purchase information includes binary data such as images, a product information vector may be generated on the basis of the amount of features (feature text, for example,) obtained by analyzing the binary data.

The user vector generation unit 104 has a function of generating a user vector from the product information vector generated using the product information vector generation unit 103 on the basis of the previous purchase information of the user. The user vector generation unit 104 generates, for example, one or more user vectors which maximize the cosine similarity among a plurality of product information vectors. The number of user vectors and the length of the dimensions are not particularly limited. The plurality of user vectors and the plurality of lengths of the dimensions may have provided. Such a user vector is stored in the user vector DB 105. A plurality of user vectors may be provided. Thus, for example, the diverse interests of an individual such as liking intense music like rock but preferring lightly flavored food may be held as information.

In generating such a user vector, weighting may be introduced. For example, in generating a user vector, weights which are linked to the likes and dislikes, level, and frequency of products previously purchased by the user, the time of the product purchase of the user, the strength of the interest and preferences of the user, for example, may be assigned. The weighting may be determined on the basis of a quantitative value associated with behavior relating to purchasing the product or content such as the evaluation score for the product, the frequency with which the subject user or other users purchase the product, or the frequency with which a website on which the product is posted is accessed. Furthermore, the weight assigned to each user vector may be determined, for example, in accordance with the amount of purchase information that is a source of the vector. For example, a weight of a user vector generated on the basis of a larger amount of purchase information may be set to be higher than that of a user vector generated on the basis of less purchase information. The weight of each of the plurality of user vectors may be determined on the basis of the number of pieces of information relating to a plurality of previous purchase products used for generating the user vector.

The target product information acquisition unit 106 has a function of acquiring information of the target product published on the platform used by the user, for example, via the user terminal 20 or directly from the EC server 40. The information of the target product which will be acquired is the same as the purchase information described above. For example, the target product information acquisition unit 106 acquires information of the target product from the site the user is browsing or related sites. The acquired information is output to the product information vector generation unit 103. The product information vector generation unit 103 generates a target product information vector for the acquired information of the target product using the same means as described above.

The recommendation information output unit 107 has a function of comparing a user vector acquired from the user vector DB 105 with a target product information vector and outputting recommendation information. The recommendation information includes information regarding a product which is recommended to the user as a result of the above comparison, among the target products. Such recommendation information may be output to the user terminal 20 via the EC server 40 or directly. An output mode is not particularly limited.

The recommendation information output unit 107 calculates, for example, a similarity between the user vector and each target product information vector of the target product as an interest index. Recommendation products may be identified on the basis of this interest index. Regarding the output of the recommendation product, for example, only the product with the highest interest index may be output or the products may be presented in order of increasing interest index or products with an interest index exceeding a certain threshold value may be presented.

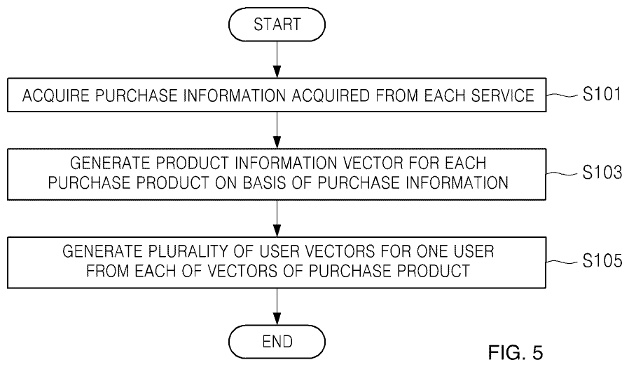

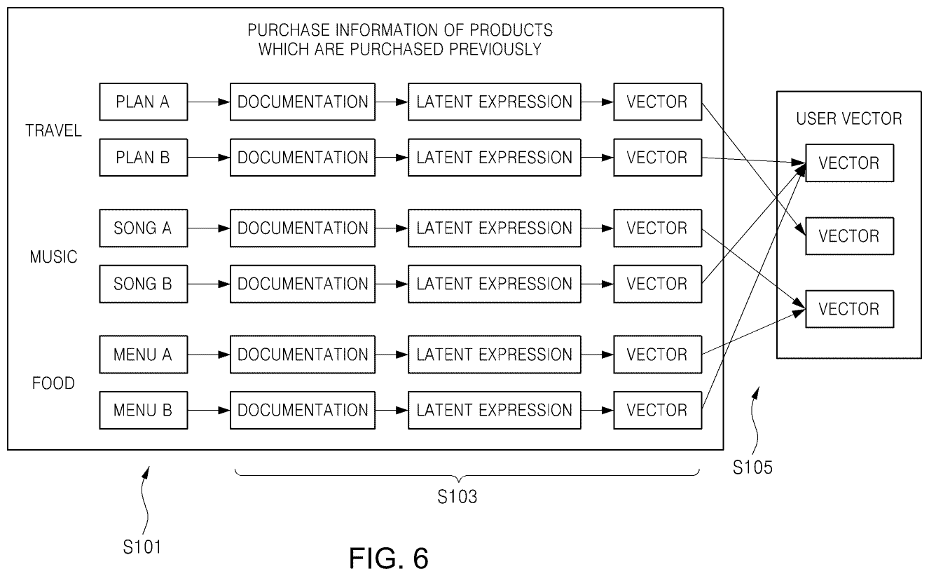

A process of generating a user vector using the information processing device 10 according to the embodiment will be described below. FIGS. 5 and 6 are a flowchart and an explanatory diagram for describing an example of a flow of a user vector generation process of the information processing system 1 according to the embodiment. First, in Step S101, the purchase information acquisition unit 101 of the information processing device 10 acquires the purchase information of the user acquired from each service from, for example, the purchase information DB 102 or the EC server 30. Examples of the purchase information include text explaining the product data of each platform provided by the EC server 30 (for example, travel plans, music titles and lyrics, food menus), images, audio, and other data.

Subsequently, in Step S103, the product information vector generation unit 103 generates a product information vector for each purchase product on the basis of the purchase information. Here, the product information vector generation unit 103 converts each data in the purchase information into a latent representation (characterizes it) and generates a vector corresponding to each data. In this case, each piece of data may be converted into text or image data or audio data may be used as is. Furthermore, each data may be summarized or characterized by means of LLM, for example.

Subsequently, in Step S105, the user vector generation unit 104 generates a plurality of user vectors for one user from each of the vectors of the purchase product. The user vector is generated by, for example, generating a plurality of vectors which maximize the cosine similarity from among the vectors corresponding to the purchase product described above. Such a user vector may be expressed, for example, through the following Expression 1.

$$arg {max}_{{U}_{1} , … , {U}_{k} , {w}_{j}^{U}} {\sum }_{i = 1}^{n} {max}_{j} {w}_{i}^{p} {w}_{j}^{U} cos ( {x}_{i} , {U}_{j} ) \qquad [ Expression 1 ]$$

In the above expression, wᵢ^{p} is a weight for a product purchased previously and may be set appropriately based on the frequency of previous product purchases, the preferences, and the interests of the user, for example. Furthermore, wⱼ^{U} is a weight of a user vector. A weight of a user vector may be constrained so that a sum thereof is 1. The dimension of the user vector obtained herein is not particularly limited.

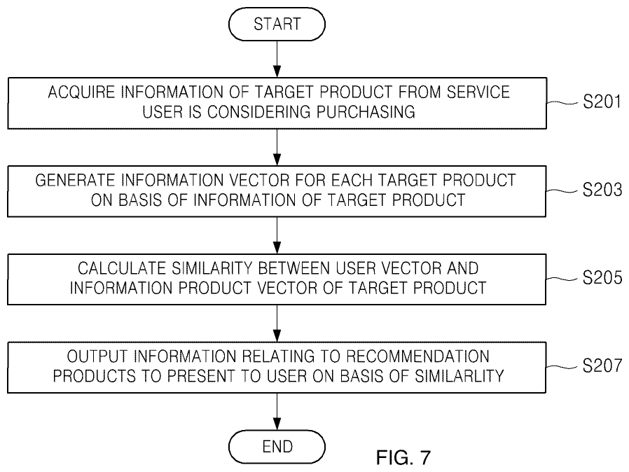

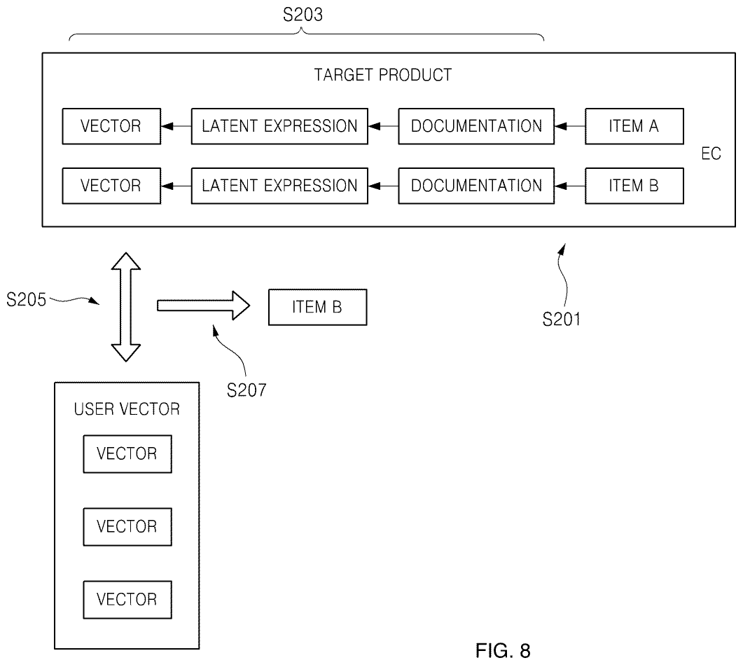

A recommendation product output process using the information processing device 10 according to the embodiment will be described below. FIG. 7 and FIG. 8 are a flowchart and an explanatory diagram for describing an example of a flow of the recommendation product output process of the information processing system 1 according to the embodiment. First, in Step S201, the target product information acquisition unit 106 acquires information of the target product from an arbitrary service, for example, the user terminal 20 or the EC server 40. The information of the target product is the same as the purchase information described above. The arbitrary service may be, for example, a service that the user is accessing via a browser, for example, to consider purchasing or using or it may be a service that the user is not accessing.

Subsequently, in Step S203, the product information vector generation unit 103 generates a product information vector for each target product on the basis of the information of the target product. Such a process is the same in Step S103 described above and thus the details thereof will be omitted.

Subsequently, in Step S205, the recommendation information output unit 107 calculates a similarity between the user vector and the information product vector of the target product. Here, for example, a similarity between a vector corresponding to a target product and a user vector is calculated using the following Expression 2 and is calculated as an interest index.

$${max}_{j} {w}_{j}^{U} cos ( {x}_{i} , {U}_{j} ) \qquad [ Expression 2 ]$$

In the above expression, wⱼ^{U} is a weight of a user vector.

Subsequently, in Step S207, the recommendation information output unit 107 outputs information regarding the recommendation product to be presented to the user on the basis of the similarity. For example, the recommendation information output unit 107 outputs, as a recommendation product, information regarding a target product (item B in the example shown in FIG. 8) which satisfies a specific condition such as maximizing the interest index, exceeding a predetermined threshold value, or ranking high. The recommendation product information may be output to the user terminal 20. Such products are products which will be recommended to the user. Such an output may not only be sent to the user terminal 20, but may also be stored in advance in an arbitrary database for example. The user may obtain the recommendation product information by accessing the database, for example, from the user terminal 20 via a browser, for example.

According to the embodiment, a recommendation product which has the preferences of the user, for example, included therein may be provided to the user with high accuracy across platforms using a user vector generated on the basis of merchandise previously purchased on a plurality of platforms such as electronic commerce sites. Thus, for example, the following recommendation output is obtained.
Recommend hotels for surfers to people with history of purchasing surfing goods
Purchase history 1: Surfboard
Purchase history 2: Wetsuit
Hotels available for reservation: Hotels for surfers
   Recommend art hotels to people with history of purchasing art goods such as oil paints
Purchase history: Oil paints
Hotels available for reservation: Art hotels
   Recommend hotels that allow pets to people with a history of purchasing dog goods
Purchase history: Dog food
Hotels available for reservation: Hotels which allow pets

A modified example of the embodiment will be described below. For example, the information processing device 10 may generate predictive models of vectors relating to purchase products, user vectors, and vectors relating to target products associated with users with little accumulated data using data regarding vectors relating to purchase products, user vectors, and vectors relating to target products for a plurality of users in the past. Thus, it is possible to improve the accuracy of product recommendations even for users who have only recently started using the service. In this case, for example, by adding information regarding the attributes of the user to the user vector, it is possible to further improve the prediction accuracy. The prediction performed herein may be performed, for example, through reinforcement learning or through mathematical vector manipulation or extrapolation. In this way, the information processing device 10 may generate predictive information regarding at least one of information relating to a purchase product, a user vector, and information of the target product associated with each of a plurality of users on the basis of at least one of information relating to a purchase product, a user vector, and information of the target product associated with another user.

Also, time information may be taken into account in generating vectors of purchase products and target products. Examples of the time information include information regarding the season, the age, and the life stage of the user. Such time information may be obtained directly or predicted, for example, through keyword analysis or natural language processing of the purchase product or the target product. By using such time information, it becomes possible to provide recommendations to users at appropriate times.

Also, information regarding the previous purchase history of the user may be used. By incorporating such information into the generation of the user vector, it is possible to more accurately predict what the user will need next. For example, for a user who has purchased a refrigerator, instead of recommending the refrigerator itself, weights may be assigned to the user vector to recommend a group of products which are highly relating to the refrigerator such as a microwave oven, food, storage cases, and ice trays. Such information regarding the purchase product history may be obtained directly or predicted through keyword analysis, and natural language processing, for example.

Furthermore, the information processing device 10 may measure a distance between different users. The information processing device may, for example, detect similar users. Thus, it is possible to use the results of recommendations for other users or to provide an output based on clustering information (for example, grouping users).

The information processing performed using an external device such as the information processing device 10 may be in the form of an on-premise or in the form of a cloud. As an external device in a cloud format, the above functions and processes may be provided, for example, in the form of a Software as a Service (SaaS) or cloud computing.

Although the information processing device 10 performs various storage and control operations in the above embodiment, a plurality of external devices may be used, instead of the information processing device 10. That is to say, various information and programs may be distributed and stored in a plurality of external devices using a blockchain technique, for example.

The above embodiment is not limited to the information processing system 1 and may be an information processing method or an information processing program. The information processing method includes each step of the information processing system 1. The information processing program causes at least one computer to perform each step of the information processing system 1.

The information processing system 1, for example, may be provided in the following manner.

### (Item 1)

An information processing method includes
acquiring information relating to a plurality of previous purchase products of each user in a plurality of electronic commerce means,
generating a plurality of user vectors relating to the user on the basis of the acquired information relating to the plurality of previous purchase products, and
outputting information relating to a recommendation product for the user on the basis of the similarity between a vector generated on the basis of information relating to a target product in one electronic commerce means and at least one vector among a plurality of user vectors relating to the user.

### (Item 2)

In the information processing method set forth in Item 1,
a vector for each of pieces of the acquired information relating to the plurality of previous purchase products is generated and a plurality of user vectors relating to the user are generated on the basis of the plurality of vectors.

### (Item 3)

In the information processing method set forth in Item 1 or 2,
the information relating to the plurality of previous purchase products includes text data, image data, or audio data relating to the plurality of previous purchase products.

### (Item 4)

In the information processing method set forth in Item 3,
the information relating to the plurality of previous purchase products includes summary information and/or feature information relating to the plurality of previous purchase products.

### (Item 5)

In the information processing method set for the in Item 3 or 4,
the information relating to the plurality of previous purchase products includes time information of the plurality of previous purchase products.

### (Item 6)

In the information processing method set for the in any one of Items 1 to 5,
a plurality of user vectors relating to the user are generated further using weights associated with the acquired information relating to the plurality of previous purchase products.

### (Item 7)

In the information processing method set for the in any one of Items 1 to 6,
a weight is assigned to each of the plurality of user vectors.

### (Item 8)

In the information processing method set for the in Item 7,
the weight of each of the plurality of user vectors is determined on the basis of the number of pieces of information relating to the plurality of previous purchase products used in generating the user vector.

### (Item 9)

In the information processing method set forth in any one of Items 1 to 8,
on the basis of at least one of information relating to a purchase product associated with each of a plurality of users, a user vector, and information of the target product, prediction information regarding at least one of information relating to a purchase product associated with another user, the user vector, and the information of the target product is generated.

### (Item 10)

In the information processing method set forth in any one of Items 1 to 9,
information relating to a recommendation product for the user is output further using information regarding the purchase product history of the user.

### (Item 11)

An information processing system includes
a purchase information acquisition unit which acquires information relating to a plurality of previous purchase products of each user in a plurality of electronic commerce means,
a user vector generation unit which generates a plurality of user vectors relating to the user on the basis of the acquired information relating to the plurality of previous purchase products, and
a recommendation information output unit which outputs information relating to a recommendation product for the user on the basis of a similarity between a vector generated on the basis of the information of the target product in one electronic commerce means and at least one vector among a plurality of user vectors relating to the user.

### (Item 12)

A program causing a computer to function as an information processing system includes, by a processor,
acquiring information relating to a plurality of previous purchase products of each user in a plurality of electronic commerce means,
generating a plurality of user vectors relating to the user on the basis of the acquired information relating to the plurality of previous purchase products, and
outputting information relating to a recommendation product for the user on the basis of the similarity between a vector generated on the basis of information relating to a target product in one electronic commerce means and at least one vector among a plurality of user vectors relating to the user.

Finally, although various embodiments according to the present disclosure have been described, these are presented as examples and are not intended to limit the scope of the disclosure. The new embodiment can be embodied in various other forms and various omissions, substitutions, and modifications can be made without departing from the spirit of the disclosure. Such embodiments and variations thereof are intended to fall within the scope and spirit of the disclosure and are included in the scope of the disclosure and its equivalents as described in the claims.

1. An information processing method, comprising:
acquiring information relating to a plurality of previous purchase products of each user in a plurality of electronic commerce means;
generating a plurality of user vectors relating to the user on the basis of the acquired information relating to the plurality of previous purchase products; and
outputting information relating to a recommendation product for the user on the basis of the similarity between a vector generated on the basis of information relating to a target product in one electronic commerce means and at least one vector among a plurality of user vectors relating to the user.

2. The information processing method according to claim 1, wherein a vector for each of pieces of the acquired information relating to the plurality of previous purchase products is generated and a plurality of user vectors relating to the user are generated on the basis of the plurality of vectors.

3. The information processing method according to claim 1, wherein the information relating to the plurality of previous purchase products includes text data, image data, or audio data relating to the plurality of previous purchase products.

4. The information processing method according to claim 3, wherein the information relating to the plurality of previous purchase products includes summary information and/or feature information relating to the plurality of previous purchase products

5. The information processing method according to claim 3, wherein the information relating to the plurality of previous purchase products includes time information of the plurality of previous purchase products.

6. The information processing method according to claim 1, wherein a plurality of user vectors relating to the user are generated further using weights associated with the acquired information relating to the plurality of previous purchase products.

7. The information processing method according to claim 1, wherein a weight is assigned to each of the plurality of user vectors.

8. The information processing method according to claim 7, wherein the weight of each of the plurality of user vectors is determined on the basis of the number of pieces of information relating to the plurality of previous purchase products used in generating the user vector.

9. The information processing method according to claim 1, wherein, on the basis of at least one of information relating to a purchase product associated with each of a plurality of users, a user vector, and information of the target product, prediction information regarding at least one of information relating to a purchase product associated with another user, the user vector, and the information of the target product is generated.

10. The information processing method according to claim 1, wherein information relating to a recommendation product for the user is output further using information regarding a purchase product history of the user.

11. An information processing system, comprising:
a purchase information acquisition unit which acquires information relating to a plurality of previous purchase products of each user in a plurality of electronic commerce means;
a user vector generation unit which generates a plurality of user vectors relating to the user on the basis of the acquired information relating to the plurality of previous purchase products; and
a recommendation information output unit which outputs information relating to a recommendation product for the user on the basis of a similarity between a vector generated on the basis of information of the target product in one electronic commerce means and at least one vector among a plurality of user vectors relating to the user.

12. A non-transitory computer readable medium storing therein a program causing a computer to function as an information processing system, comprising: by a processor,
acquiring information relating to a plurality of previous purchase products of each user in a plurality of electronic commerce means;
generating a plurality of user vectors relating to the user on the basis of the acquired information relating to the plurality of previous purchase products; and
outputting information relating to a recommendation product for the user on the basis of the similarity between a vector generated on the basis of information relating to a target product in one electronic commerce means and at least one vector among a plurality of user vectors relating to the user.
